(19) United States
(12) Patent Application Publication
(10) Pub. No.: US 2003/0018744 A1
(43) Pub. Date: Jan. 23, 2003

(54) Bluetooth device position display

(76) Inventors: James A. Johanson, Macungie, PA (US); Joseph M. Cannon, Harleysville, PA (US); Philip D. Mooney, Sellersville, PA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/777,884

(22) Filed: Feb. 7, 2001

(51) Int. Cl. G06F 15/16

(52) U.S. Cl. 709/217

(57) ABSTRACT

A system and method for displaying the location of nearby electronic devices location relative to a user device. An electronic user device transmits a GPS coordinate request to all nearby electronic devices. The nearby electronic devices respond with their device GPS location information and then the user device displays the location of each electronic device that responded relative to the user device location.

### FIELD OF THE INVENTION

The present invention relates to a method and apparatus for allowing a user to select an electronic device to communicate with based on the location of the electronic device.

### BACKGROUND OF THE INVENTION

In recent years, use of portable electronic devices has increased greatly. Electronic devices and home appliances are increasingly being manufactured with transceivers and controllers. As a consequence, it is also becoming more difficult for a wireless device to select to which wireless device a connection is desired. A user looking at a display of wireless device addresses can not easily determine which address represents a device the user desires to connect with.

Some software tools allow names to be associated with each device address. When a new device is encountered, the user can name the device in an identifiable way and the name associated with that device address is stored for future reference. This method would not work well in a mobile environment where new devices are encountered all the time.

In addition, there are times when selection of a device based on its location relative to the wireless user rather than its name is preferable. For example, if each printer on a floor of an office was named, a wireless user may want to select the closest printer without finding out thc name of the printer. Also, if a user were in a car and a desired device in another car in front, in back of, or next to the user, a visual display of location of each device could allow a wireless user to communicate with a desired car in front, in back of, or next to the user.

Thus, there exists a desire and need for a system and method which makes it easy to select a nearby wireless electronic devices to communicate with.

### BRIEF SUMMARY OF THE INVENTION

The present invention mitigates the problems associated with the prior art and provides a unique method and system for communicating with nearby wireless electronic devices.

In accordance with an exemplary embodiment of the present invention, electronic devices such as, for example, computers, laptops, cellular telephones, televisions, VCRs, stereos, pagers, etc. are provided with, or may already have, transceivers. When the user activates the input of a wireless device, a transceiver thereat transmits a low power radio signal requesting GPS coordinates of each electronic device within range. Each device that is within range to receive the request signal responds with a signal containing its GPS coordinates. Once the user device receives GPS coordinates from each electronic device, it displays each device in its respective location. Once the display is shown to the user, the user can select a device based on its location. After the device is selected, communications software that is either incorporated into the present invention or is operated independently can communicate between the user's device and the desired device. Thus, for example, the present invention allows a user at a meeting to select a laptop to transmit a message to based on the location of the laptop relative to the user. The present invention may also allow a user to communicate with someone in a car near the user while on the road. The present invention also allows a user to transmit a message to someone's cell phone just by knowing where that person is relative to the user.

### BRIEF DESCRIPTION OF THE DRAWINGS

The above and other features and advantages of the invention will be more readily understood from the following detailed description of the invention which is provided in connection with the accompanying drawings.

FIG. 1 is a block diagram of an electronic device equipped to communicate with nearby electronic devices;

FIG. 2 is a flowchart of the operation of an electronic device for an exemplary method to allow an electronic device to communicate with nearby electronic devices;

FIG. 3 is a flowchart of the operation of nearby electronic devices for an exemplary method to allow an electronic device to communicate with nearby electronic devices;

FIG. 4 is a flowchart of the operation of an electronic device for an exemplary method to allow an electronic device to communicate with nearby electronic devices where nearby electronic devices automatically transmit their location coordinates when entering a pico-net; and

FIG. 5 is a flowchart of the operation of nearby electronic devices for an exemplary method to allow an electronic device to communicate with nearby electronic devices where nearby electronic devices automatically transmit their location coordinates when entering a pico-net.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to make and use the invention, and it is to be understood that structural changes may be made and equivalent structures substituted for those shown without departing from the spirit and scope of the present invention.

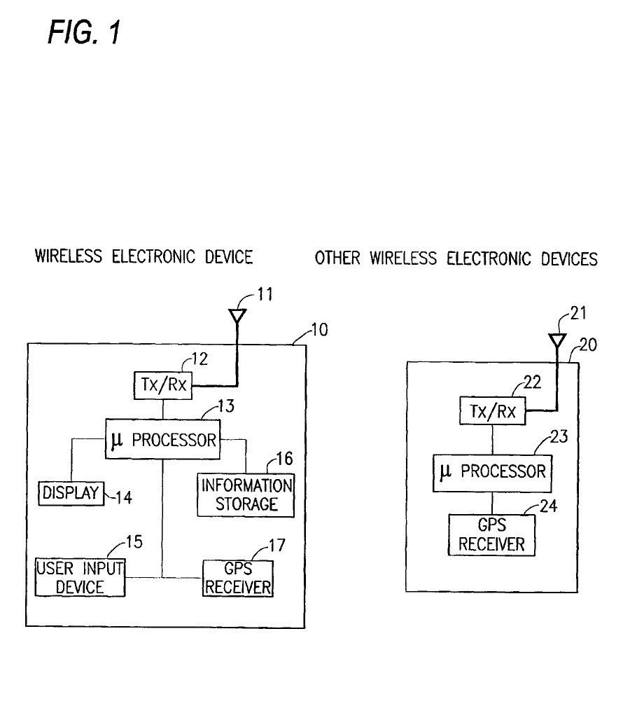

FIG. 1 illustrates in block diagram form an electronic device which is useable in the present invention. In accordance with the present invention, a first electronic device 10 communicates with all nearby electronic devices to obtain the GPS location of each device. The first electronic device 10 then displays where each other electronic device is in relation to the first electronic device 10 so the user can select an electronic device to communicate with.

A user electronic device 10, such as, for example, a computer, a laptop, a cellular telephone, a PDA, etc., is provided with a transceiver 12. The transceiver 12 is connected to a controller, for example, a microprocessor 13, and is provided with an antenna 11 for broadcasting and receiving radio signals. The electronic device 10 is also provided with a user input device 15 for selecting which other electronic device to communicate with. The input device 15 may be a keyboard, mouse, keypad, touch screen, etc. The electronic device 10 is also provided with an information storage device and a GPS receiver.

Other electronic devices 20, such as, for example, computers, laptops, printers, scanners, cellular telephones, PDAs, automobiles, pagers, etc., likewise have transceivers 22. The transceiver 22 is connected to a controller, for example, a microprocessor 23, and is provided with an antenna 21 for broadcasting and receiving radio signals. The other electronic devices 20 are also provided with GPS receivers 24.

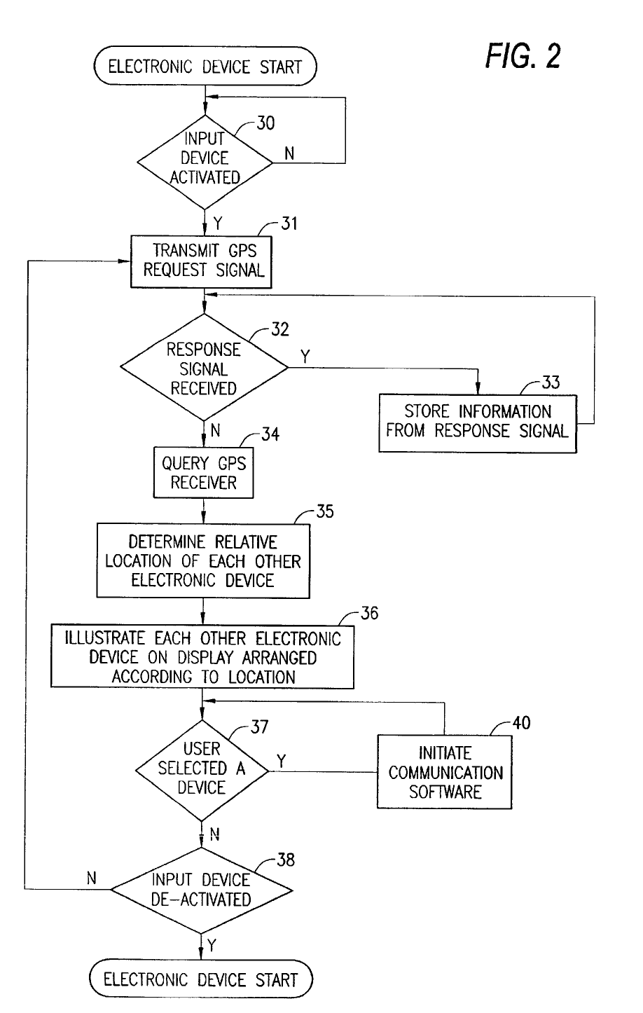

In accordance with an exemplary embodiment of the present invention, other electronic devices 20 which can communicate with electronic device 10, such as, for example, computers, laptops, cellular telephones, televisions, VCRs, stereos, pagers, etc. are all provided with transceivers and GPS receivers. The manner in which electronic devices operate will now be described with reference to FIGS. 1, 2 and 3. The microprocessor 13 of electronic device 10 controls operations at electronic device 10, as shown in FIG. 2, it checks if the input device 15 is activated at processing segment 30. If the input device is not activated as detected at processing segment 30, the microprocessor 13 returns to a start state.

If the input device is activated as detected at processing segment 30, the microprocessor 13 transmits a signal requesting the GPS location and device type (e.g. cellular telephone, computer, printer, PDA, etc.) information of all nearby electronic devices at segment 31. The microprocessor 13 then checks if any response signals are received at processing segment 32. If a response signal is received at processing segment 32, the microprocessor stores the GPS location and device type information contained in the response signal in the information storage device 16 in association with identification information for the responding device. The microprocessor 13 then returns to processing segment 32 to check if another response signal is received.

When no more response signals are received as detected at processing segment 32, the microprocessor 13 queries the GPS receiver 17 at segment 34 and determines the location of each electronic device 20 that responded relative to the location of electronic device 10 at segment 35. The microprocessor 13 then illustrates each other electronic device 20 as an icon corresponding to the device type of each other electronic device 20 on the display 14 arranged according to their relative locations and altitudes to electronic device 10 at segment 36. If the area displayed is too large, the user can set the maximum distance that an electronic device 20 can be from the user and still be displayed. At this point, the user can select an electronic device 20 to communicate with at processing segment 37, by, for example, keyboard, mouse, touch pad input, touch screen, etc. If the user selects a device to communicate with at processing segment 37, the microprocessor 13 begins a communication routine with the selected device and returns to processing segment 37 so that the user can select another electronic device 20.

If the user does not select a device to communicate with as detected at processing segment 37, the microprocessor 13 checks if the user de-activated the user interface at processing segment 38. If the user input device 15 was not deactivated as detected at processing segment 38, the microprocessor 13 returns to processing segment 31 to transmit a GPS coordinate and device type request signal again so that any additional devices within range can be displayed and the positions of the devices already displayed can be updated. If input device 15 was deactivated at processing segment 38, the microprocessor 13 returns to a start state.

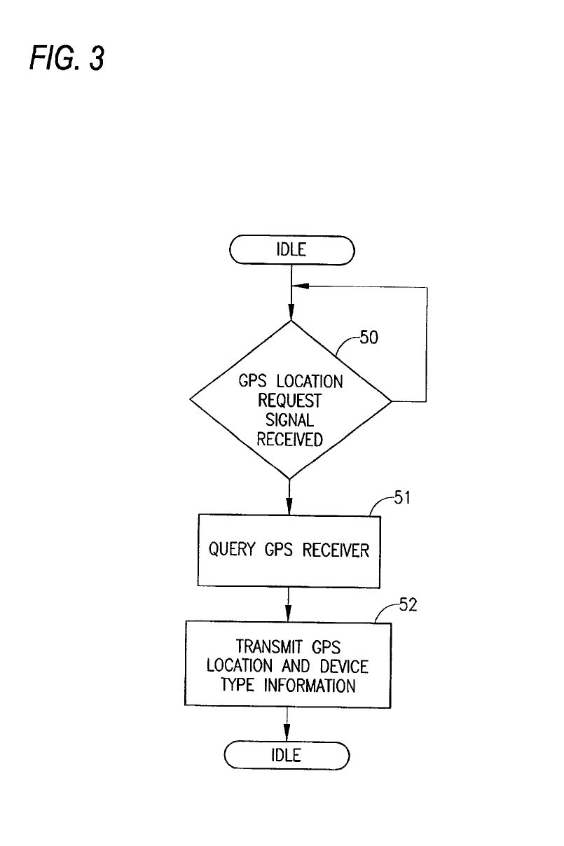

FIG. 3 illustrates in flowchart form the processing performed by nearby electronic devices 20. If a GPS location request signal is not received at processing segment 50, the microprocessor 23 returns to a start state. If transceiver 22 receives a GPS location request signal as detected at processing segment 50, the microprocessor 23 queries the GPS receiver 24 at segment 51. Transceiver 22 then transmits the GPS location information at segment 52 and returns to a start state.

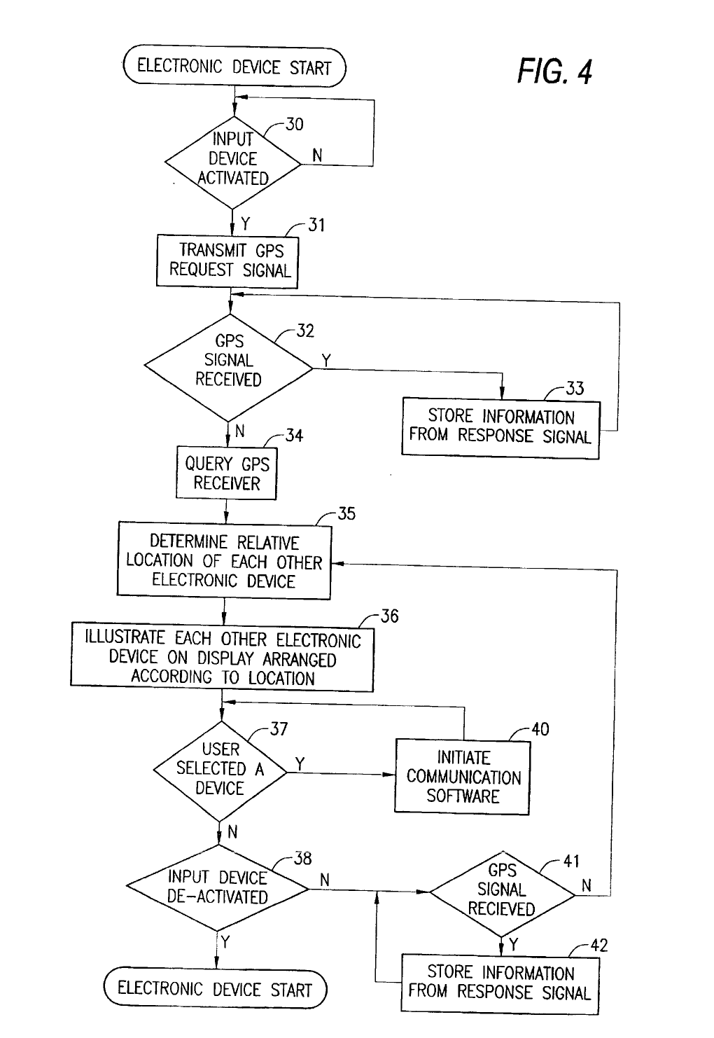

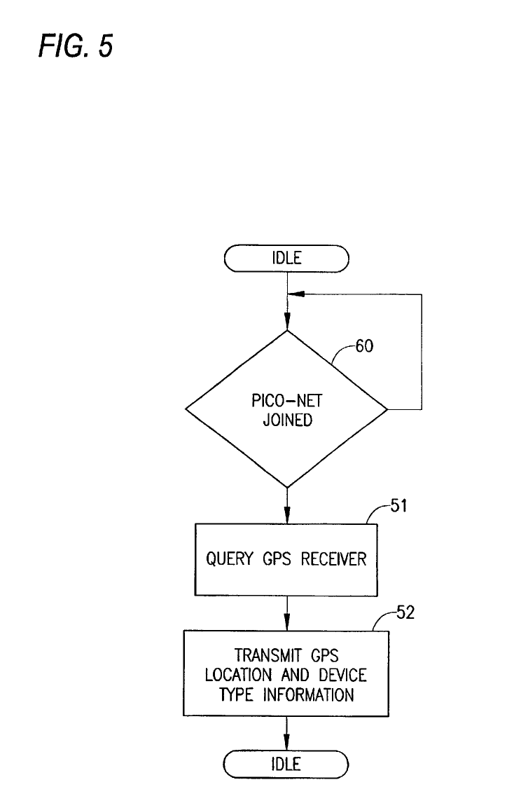

FIGS. 4 and 5 illustrate in flowchart form a modification of how a device position display can operate. In this modification, instead of querying the nearby electronic devices 20 regularly to obtain the location of the nearby electronic devices 20, the nearby electronic devices transmit their location when entering a pico-net. The difference between FIG. 4 and FIG. 2 is the addition of processing segment 41 and segment 42. The difference between FIG. 5 and FIG. 3 is that segment 50 is changed to segment 60 so that the GPS coordinates will be transmitted when a pico-net is joined instead of when a GPS location request signal is received.

As illustrated in FIG. 4, when the input device 15 is not deactivated as detected at processing segment 38, microprocessor 13 checks if a GPS signal is received at processing segment 41. If a GPS signal is received as detected at processing segment 41, microprocessor 13 stores the information from the GPS signal in information storage device 16 at segment 42 and returns to processing segment 41 to check if additional GPS signals were received. If a GPS signal is not received as detected at processing segment 41, microprocessor 13 returns to segment 35 to adjust the display 14 to include any additional devices.

In order to standardize the system for various products from different manufacturers, a protocol must be established. One such protocol is known as Bluetooth™. Bluetooth™ is a radio frequency standard that describes how portable electronic devices, such as, for example, wireless telephones, PDAs, and personal computers, can easily interconnect with each other and with home and business phones and computers using a short-range wireless connection. The Bluetooth™ specification ensures that diverse devices supporting the Bluetooth™ technology can communicate with each other worldwide. The Bluetooth™ protocol allows for the automatic connections between the devices without any user intervention. Thus, when Bluetooth™ equipped devices come within range of one another, such as, for example, when an electronic device 10 is within range of other electronic devices 20, the devices can communicate with each other via a radio frequency.

While the Bluetooth™ protocol can be used with the present invention, the communications do not have to be by the Bluetooth™ protocol, and other standardized or proprietary protocols may also be used. Although the invention has been described with reference to using GPS coordinates to determine each electronic device's location, this is not required and an electronic device can use triangulation to determine the other electronic devices' location relative to itself.

While the invention has been described with reference to an exemplary embodiments various additions, deletions, substitutions, or other modifications may be made without departing from the spirit or scope of the invention. Accordingly, the invention is not to be considered as limited by the foregoing description, but is only limited by the scope of the appended claims.

What is claimed as new and desired to be protected by Letters Patent of the United States is:

1. A system for communicating with nearby electronic devices comprising:
a first electronic device;
at least one other electronic device;
said first electronic device broadcasting a first signal requesting location coordinates from electronic devices within range; and
said at least one other electronic device within a predetermined range of said first electronic device receiving said first signal and transmitting a second response signal containing its location coordinates.

2. The system as in claim 1, wherein said first electronic device receives said second response signals and visually displays said at least one other electronic device indicating the position of said at least one other electronic device relative to said first electronic device.

3. The system as in claim 1, wherein the maximum distance said at least one other electronic device can be from said electronic device and be displayed is adjustable.

4. The system as in claim 1, wherein said second response signal includes the type of said at least one electronic device in said second response signal.

5. The system as in claim 4, wherein said first electronic device displays the type of said at least one other electronic device.

6. The system as in claim 1, wherein one of said at least one other electronic devices can be selected at said electronic device to communicate with said electronic device.

7. The system as in claim 1, wherein said first and second signals are radio signals.

8. The system as in claim 7, wherein said radio signals are Bluetooth™ compliant.

9. An electronic device comprising:
a transceiver;
a controller coupled to said transceiver;
a display screen coupled to said controller;
a user input device coupled to said controller; and
a GPS receiver coupled to said controller;
said controller operating in response to a first input at said electronic device to cause said transceiver to transmit a first signal requesting a response signal from another electronic device containing the GPS coordinates of said another electronic device;
said controller further operating in response to receipt of said response signal from said another electronic device to visually display on said display screen the position of said another electronic device relative to said first electronic device.

10. The device as in claim 9, wherein said first signal also requests the device type of said another electronic device.

11. The device as in claim 10, wherein said visual display also includes the device type of said another electronic device.

12. The device as in claim 9, wherein said controller further operates in response to receipt of response signals from a plurality of electronic devices to visually display on said display screen the position of each of said plurality of electronic devices relative to said first electronic device.

13. A device as in claim 9, wherein said first and second signals are radio signals.

14. A device as in claim 13, wherein said radio signals are Bluetooth™ compliant.

15. An electronic device comprising:
a transceiver;
a controller coupled to said transceiver; and
a GPS receiver coupled to said controller;
said controller operating in response to receipt a first signal from another electronic device requesting the GPS coordinates of said electronic dcvice;
said controller causing a second response signal containing the GPS coordinates of said electronic device to be transmitted.

16. The device as in claim 15, wherein said first signal also requests the device type of said electronic device and said second response signal also includes the device type of said electronic device.

17. A device as in claim 15, wherein said first and second signals are radio signals.

18. A device as in claim 17, wherein said radio signals are Bluetooth™ compliant.

19. A method for communicating with nearby electronic devices comprising the steps of:
transmitting a first signal from a user location to at least one electronic device requesting GPS coordinates;
detecting said first signal at said at least one electronic device;
transmitting a second signal from said at least one electronic device to said user location containing the GPS coordinates of said at least one electronic device;
detecting said second signal containing the GPS coordinates of said at least one electronic device at said user location; and
displaying the location of said at least one electronic device associated with a received second signal relative to the user location.

20. A method as in claim 19, further comprising the step of
selecting one of said at least one electronic device at said user location according to said displayed location of said at least one electronic device;
said user location communicating with said selected electronic device.

21. A method as in claim 19, wherein said first and second signals are radio signals.

22. A method as in claim 21, wherein said radio signals are Bluetooth™ compliant.

23. A method for communicating with nearby electronic devices comprising the steps of:
displaying the location of at least one other electronic device relative to a user electronic device;
selecting a target electronic device according to said displayed location; and
communicating with said selected electronic device.

24. A method as in claim 23, further comprising the steps of:
transmitting a first signal from a user location to at least one electronic device requesting location coordinates;
detecting a second signal containing the location coordinates of said at least one electronic device at said user location.

25. A method as in claim 24, wherein said first and second signals are radio signals.

26. A method as in claim 25, wherein said radio signals are Bluetooth™ compliant.

27. A method for communicating with nearby electronic devices comprising the steps of:
detecting a first signal at an electronic device requesting the location coordinates of said electronic device;
transmitting a second response signal containing the location coordinates of said electronic device.

28. A method as in claim 27, wherein said first and second signals are radio signals.

29. A method as in claim 28, wherein said radio signals are Bluetooth™ compliant.
